(19) United States
(12) Patent Application Publication
(10) Pub. No.: US 2001/0015825 A1
(43) Pub. Date: Aug. 23, 2001

(54) Method and apparatus for encoding image data in conformity with joint bi-level image group system

(75) Inventor: Tomoki Ayabe, Kanagawa (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/788,569

(22) Filed: Feb. 21, 2001

(30) Foreign Application Priority Data
Feb. 23, 2000 (JP) 2000-046462

(51) Int. Cl. H04N 1/417

(52) U.S. Cl. 358/261.2; 358/430

(57) ABSTRACT

A method for encoding image data in conformity with Joint Bi-level Image Group system, comprising the steps of: (a) determining whether or not a typical prediction should be performed; (b) if a result of determination at step (a) is negative, determining whether or not all the pixels in a region composed of lines including pixels constituting a context are white; (c) if a result of determination at step (b) is affirmative, determining whether or not a predicted value corresponding to a context of which all the pixels are white is white; (d) if the result of determination at step (a) is affirmative, if the result of determination at step (b) is negative, or if a result of determination at step (c) is negative, performing a first single line encoding process; and (e) if the result of determination at step (c) is affirmative, performing a second single line encoding process.

### BACKGROUND OF THE INVENTION

1. Field of the Invention

The present invention relates to an image data compression method, a JBIG (Joint Bi-level Image Group) system encoding processing method and its apparatus and a recording medium readable by a computer, which stores a program for having a computer execute the JBIG system encoding processing method.

2. Description of the Prior Art

As an encoding system of image data and as one of a progressive encoding system, which is suitable for a soft copy transmission, a JBIG encoding system (a facsimile version) by a recommendation T. 85 of August, 1995 of International Standard ITU-T is recommended.

According to MH (Modified Huffman: a method for compression and extension of data)/MR (Modified READ: a method for compression and extension of data)/MMR (Modified Modified READ: a method for compression and extension of data) in a conventional facsimile system, upon processing of encoding, a run-length value which is a length of continuous pixels of the same color (white or black) is obtained from pixel data, and a code corresponding to the run-length is obtained from an encoding table.

On the contrary, in the JBIG system, when compressing a target pixel, ten pixels in a periphery of the encoding target pixel are referred to in order to predict whether the encoding target pixel is white or black. Then, only in the case that an actual color is not the same as the predicted color, the JBIG system encodes the target pixel with an arithmetic encoding system.

A conventional data encoding system method in a JBIG encoding system by the ITU-T T. 85 recommendation will be explained with reference to drawings. With respect to this conventional art, Japanese Patent Application Laid-Open No. 9-149264 (Japanese Patent No. 2793536) discloses the followings.

As shown in FIG. 1, in this apparatus, a CPU (central processing unit) 100 for arithmetic processing, data processing and controlling of each unit or the like, an image data memory 400 holding a binary-value image data converted from a manuscript, which is read upon transmission, a ROM 200, in which an encoding program 201 in conformity with the JBIG system and a probability estimation table memory 202 for converting image data into an encoded data are disposed and stored, a learning table memory 300 to be referred to in order to increase probability that the color, i.e., white or black of the encoding target pixel is correctly predicted and a FIFO memory 500 for FIFO (First In First Out) managing the encode data as a result of the conversion are connected through a bus 600.

In addition, the CPU 100 has a register 101 for holding image data read out from every block in an encoding target line, a register 102 for holding image data read out from every block in a line preceding the encoding target line by one line, a register 103 for holding image data read out from every block in a line preceding the encoding target line by two lines, a register 104 for holding a prediction result, a register 105 for holding a predicted value and a status value, which have been read out from the learning table memory 300, a register 106 for holding a range width in which the prediction is unsuccessful, which is read out from the probability estimation table memory 202 and a register 107 for holding the contents of a context indicating a contextual relation of pixels.

The CPU 100 implements a data encoding method by executing the encoding program 201 in conformity with a JBIG system as explained as follows:

An entire operation of the data encoding method will be explained with reference to a flow chart in FIG. 2. At first, the method determines whether a typical prediction should be performed or not (step S21). Then, in the case of not performing the typical prediction, the method performs encoding process for one line (step S26). After that, the method determines whether process for all the lines in a manuscript have been terminated or not (step S27). Then, in the case that they have not been terminated, the method returns to the encoding processing for one line (step S26) and repeats the encoding processing. When processing for one page has been terminated, the method terminates the processing.

In accordance with the determination as to whether the typical prediction should be performed or not (step S21), in the case of performing the typical processing, the encoding target line is compared with the line preceding the encoding target line by one line (step S29) to determine whether these two lines are the same or not (step S210). In the case that the two lines are not the same, the method performs the encoding processing for one line (step S26) and determines whether the processing for one page has been terminated or not (step S27). In the case that the two lines are the same, step S26 is skipped to directly advance to step S27. In the case that the processing for one page has not been terminated, the method returns to line comparing process (step S29) to repeat the encoding processing. The above mentioned process is performed for all the lines of the manuscript, thereby finishing the encoding process.

Next, the detail of the encoding process for one line (i.e., target line) (step S26) will be explained with reference to FIG. 3. At first, it is determined whether the target line is terminated or not (step S31). If the line is terminated, the process is terminated. If the target line is not terminated, block image data out of a line H2, i.e., the line preceding the encoding target line by two lines, a block image data out of a line H1, i.e., the line preceding the encoding target line by one line and block image data out of the encoding target line PIX are formed (steps S90, S91, S92). Specifically, the image data are read out from the designated address. In this case, since the data which precede the encoding target pixel are necessary due to the structure of the context, the read image data are shifted and connected with image data which remain after preceding block process in order to form block image data.

Next, it is determined whether all the three image data blocks are white or not (step S93). If the determination result is affirmative, step S95 is repeated until the block processing is terminated.

If the determination result of the step S93 is negative, a series of process, including forming a context by arranging the pixels in the periphery of the encoding target pixel in one dimension (step S94), one pixel encoding process (step S95), shifting the image data for three blocks by one bit (step S96) is repeated until the block process is terminated (step S46).

In the case that the process for a block unit has been terminated, the process returns to the top of the encoding process for the target line to determine whether the encoding process for the target line has been terminated or not (step S31).

The CPU 100 performs the encoding process by repeating the processing for all the lines of the manuscript.

Next, the detail of the one pixel encoding process (step S95) will be explained with reference to FIG. 4 through FIG. 6. At first, the predicted value and the status value which correspond to the index which is formed of a context are read from the learning table 300 (step S100). Here, the context is formed by arranging pixels in the periphery of the target pixel in one-dimension. Then, using the status value as an index, the range width for prediction-miss is read from the probability estimation table memory 202, together with the status value when the prediction is unsuccessful, the status value when the prediction is successful, and the condition when the prediction is unsuccessful (step S41).

Furthermore, by deducting the range width for prediction-miss from the range width showing probability that combination of white and black appears, the latter range width is updated (step S42). Thereafter, it is determined whether the actual value of encoding target pixel is identical with the predicted value or not (step S110).

If the determination result at step S110 is negative, a prediction-miss process is performed (step S120), and then a normalization process is performed (step S45). In the prediction-miss process, the range width indicating the prediction-miss probability (i.e., the range for prediction-miss) is updated, the status when the prediction is unsuccessful, which has been read at step S41, is written to the concerned entry of the learning table 300, and if the condition when the prediction is unsuccessful, which has been read at step S41, requires, the predicted value in the concerned entry of the learning table is inverted. In the normalization process, the prediction-hit range width is widened to be wider than the prediction-miss range width. On the contrary, if the determination result at step S110 is affirmative, that is, prediction-hit takes place, it is determined whether the normalization process is required to be performed (step S43). If the determination result at step S43 is affirmative, a prediction-hit process is performed (step S44), and then the normalization process is performed (step S45). In the prediction-hit process, the range width indicating the prediction-hit probability (i.e., the range width in which the prediction is successful) is updated, and the status when the prediction is successful, which has been read at step S41, is written to the concerned entry of the learning table 300. If the determination result at step S43 is negative, the step S44 and S45 are skipped.

FIG. 5A depicts a scheme of a memory block in the image data memory 400 in FIG. 1. Further, FIG. 5A illustrates a page of a document so that it depicts an encoding direction of each line in a horizontal axis and the vertical direction in a vertical axis. Specifically, in order to illustrate the prediction by the JBIG system, FIG. 5A depicts the data status of the encoding target line (PIX), the line (H1), i.e., a line preceding the encoding target line by one line and the line (H2), i.e., a line preceding the encoding target line by two lines. FIG. 5B depicts the detail of a memory block, in which each line is divided into pixels.

In order to predict the encoding target pixel, as shown in a shaded area of FIG. 5B, three pixels from the line H2, which is the line preceding the PIX line by two lines, five pixels from the line H1, which is the line preceding the PIX line by one line, and two pixels from the current PIX line constitute peripheral pixels (i.e., model template) around the encoding target pixel. Assigning “0” to “9” to the ten peripheral pixels as shown in FIG. 5C, a context composed of No. “0” through “9” pixels is formed as shown in FIG. 5D. By using this context, it is predicted whether the encoding target pixel is white or black in conformity with a rule in the JBIG system.

Whether this prediction is successful or unsuccessful is detected. In the case that it is unsuccessful, the encoding target pixel is compressed by the arithmetic encoding. Simultaneously, judging whether the prediction is successful or unsuccessful for every encoding target pixel, the learning table memory 300 as shown in FIGS. 1 and 6 is updated on the basis of the judgment. By using this learning table memory 300, probability that the prediction is successful is improved. Then, by improving the prediction probability, it is possible to more effectively compress the image data.

FIG. 6 depicts examples of the learning table memory 300, which is also referred to as a context table, and the probability estimation table memory 202. The learning table memory 300 stores the predicted value and the status value for every context, in which ten pixels in the model template are arranged in one dimension. The range width for prediction-miss, the status value when the prediction is unsuccessful, the status value when the prediction is successful and the condition when the prediction is unsuccessful are obtained by using a statistical method and they are stored in the probability estimation table memory 202.

The binary value image data compression method making reference to the peripheral pixels around the encoding target pixel in conformity with the JBIG system according to this prior art was explained above.

The encoding target line and the line preceding the encoding target line by one line are compared. If they are identical to each other, the encoding target line is not encoded. Therefore, the number of processes for forming the contexts and the number of processes for reading the image memory are decreased, whereby the compression speed is enhanced.

As described above, according to a conventional image compression method in conformity with the JBIG system, it is predicted whether the encoding target pixel is white or black from the context. Then, only in the case that the prediction is not successful, the encoding target pixel is encoded. In addition, in order to decrease the amount of the encoded data, the number of cases that the prediction is not successful is decreased by learning the prediction result. Thus, for a document mainly composed of letters, the compression ratio from 1.1 to 1.5 times as high as that of a conventional MH/MR/MMR system is achieved.

However, the above-mentioned conventional art involves the following problems. A first problem is that an encoding processing rate is not speedy in the case that a typical prediction which is an option of the JBIG system is not performed. This is because formation process of an image data block for forming a context is frequently performed in block units with respect to three lines, namely, the encoding target line, the line preceding the encoding target line by one line and the line preceding the encoding target line by two lines. Another reason is that the data of pixels prior to the encoding target pixel is required due to the structure of the context, and therefore, it is necessary to connect the newly loaded image data with the prior image data to form the image data block.

Therefore, the image data following the encoding target pixel are not capable of being loaded to a register fully across the whole register width, and therefore, the image data are loaded to a part of the register. This causes an increase in the number of loadings of image data.

### SUMMARY OF THE INVENTION

In order to overcome the aforementioned disadvantages, the present invention has been made and accordingly, has an object to provide a method and system for compressing image data in conformity with the JBIG system in which process speed is enhanced.

According to the present invention, there is provided a method for encoding image data in conformity with Joint Bi-level Image Group system, comprising the steps of: (a) determining whether or not a typical prediction should be performed; (b) if a result of determination at step (a) is negative, determining whether or not all the pixels in a region composed of lines including pixels constituting a context are white; (c) if a result of determination at step (b) is affirmative, determining whether or not a predicted value corresponding to a context of which all the pixels are white is white; (d) if the result of determination at step (a) is affirmative, performing a first single line encoding process; (e) if the result of determination at step (b) is negative, performing the first single line encoding process; (f) if a result of determination at step (c) is negative, performing the first single line encoding process; and (g) if the result of determination at step (c) is affirmative, performing a second single line encoding process.

In the above method, the first single line encoding process may comprise the steps of: (d-1) forming a context for each pixel in a target line; (d-2) reading from a probability estimation table a range width for prediction-miss which corresponds to the context formed at step (d-1); (d-3) updating a range width showing probability that combination of white and black appears using the range width for prediction-miss; (d-4) predicting a value of each pixel in the target line on the basis of the context corresponding to the pixel; (d-5) if the prediction is unsuccessful, performing a prediction-miss process for the pixel concerned; and (d-6) if the prediction is unsuccessful, performing a normalization process for the pixel concerned.

In the above method, first single line encoding process may further comprise the steps of: (d-7) if the prediction is successful, determining whether or not a normalization is necessary for each pixel in the target line; (d-8) if a result of determination at step (d-7) is affirmative, performing a prediction-hit process for the pixel concerned; and (d-9) if the result of determination at step (d-7) is affirmative, performing the normalization process for the pixel concerned.

In the above method, the second single line encoding process may comprise the steps of: (g-1) forming a context of which all the pixels are white and which is common to the pixels in a target line; (g-2) reading from a probability estimation table a range width for prediction-miss which corresponds to the context formed at step (g-1); (g-3) updating a range width showing probability that combination of white and black appears using the range width for prediction-miss; and (g-4) omitting to predict a value of each pixel in the target line.

In the above method, the second single line encoding process may further comprise the steps of: (g-5) determining whether or not a normalization process is necessary for each pixel in the target line; (g-6) if a result of determination at step (g-5) is affirmative, performing a prediction hit process for the pixel concerned; and (g-7) if the result of determination at step (g-5) is affirmative, performing the normalization process for the pixel concerned.

### BRIEF DESCRIPTION OF THE DRAWINGS

FIG. 1 is a block diagram of a JBIG system encoding processing apparatus according to a conventional example;

FIG. 2 is a flow chart showing an encoding procedure of the conventional example;

FIG. 3 is a flow chart showing a detailed procedure of the processing at step S26 in FIG. 2;

FIG. 4 is a flow chart showing a detailed procedure of the processing at step S95 in FIG. 3;

FIG. 5A shows a scheme of a memory block of an image data memory;

FIG. 5B shows a structure of a line;

FIG. 5C shows a structure of a model template;

FIG. 5D shows a structure of a context;

FIG. 6 shows structures of a learning table and a probability estimation table memory.

FIG. 7 is a block diagram of a JBIG system encoding processing apparatus according to a first embodiment of the present invention;

FIG. 8 is a flow chart showing an encoding procedure according to the first embodiment of the present invention;

FIG. 9A is a flow chart showing detailed procedures of the processing at step S22 in FIG. 8 according to the present invention;

FIG. 9B is a flow chart showing detailed procedures of the processing step S26 in FIG. 8 according to the present invention; and

FIG. 10 is a flow chart showing a detailed procedure of the processing at step S30 in FIG. 9B according to the present invention;

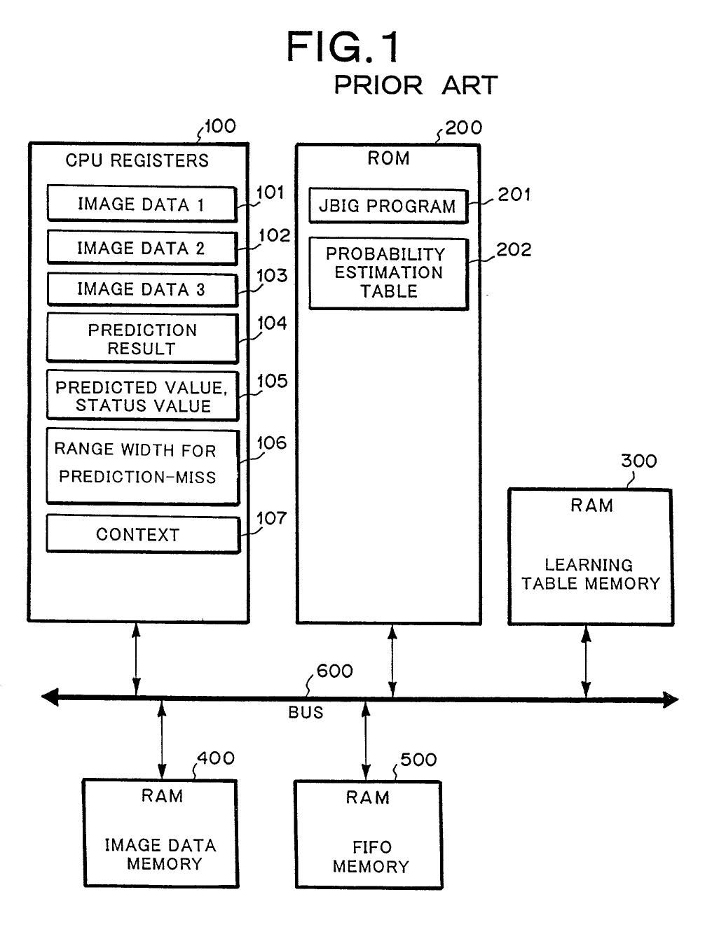

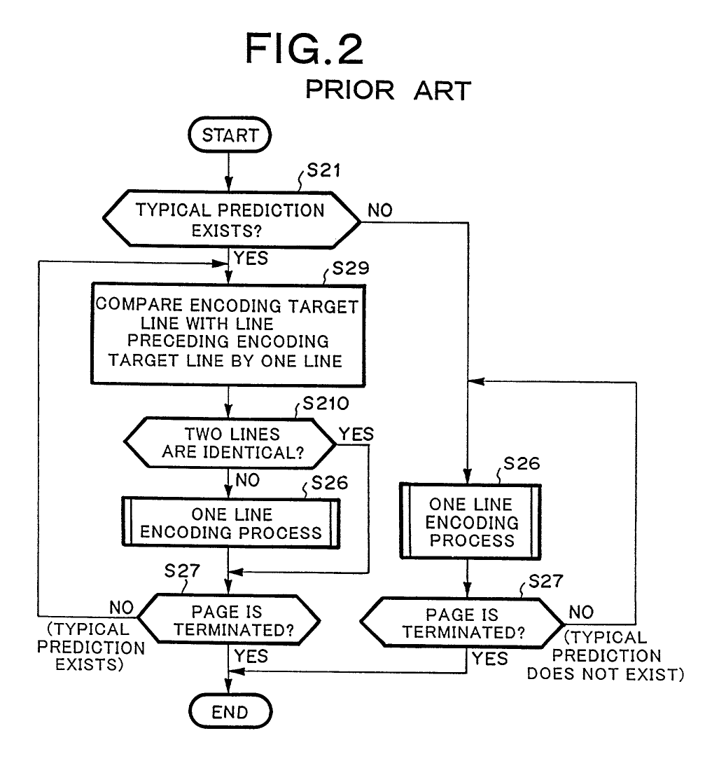

### DESCRIPTION OF THE PREFERRED EMBODIMENTS

The preferred embodiments according to the present invention will be explained in detail with reference to the drawings.

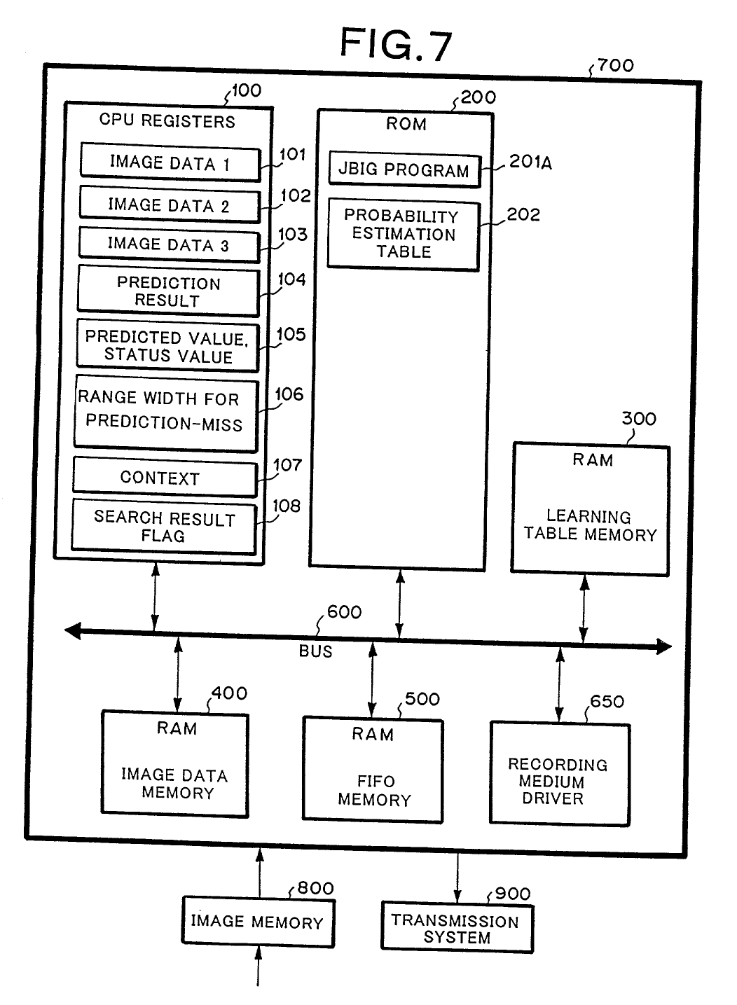

A first embodiment of the present invention will be explained with reference to the drawings. FIG. 7 is a block diagram for explaining the first embodiment of the present invention.

As shown in FIG. 7, according to the first embodiment of the present invention, a CPU (central processing unit) 100 for arithmetic processing, data processing and controlling of each unit or the like, an image data memory 400 holding binary-value image data converted from an image signal, which is read from a manuscript by a reading sensor (not illustrated), a ROM 200, in which a program 201A executed by the CPU for encoding image data in conformity with the JBIG system and a probability estimation table memory 202 for converting image data into encoded data are disposed and stored, a learning table memory 300 to be referred in order to increase the probability that the color, i.e., white or black of the encoding target pixel becomes as predicted and a FIFO (First In First Out) memory 500 are connected each other in an interior of a JBIG system encoding processing apparatus 700 through a bus 600. The learning table memory 300, the image data memory 400, and FIFO memory 500 are comprised of RAM (Random Access Memory).

RAMs 300 through 500 may be combined together within the same package, if storage areas are capable of being distinguished from one another. Additionally, a recording medium driver 650 writes the data such as the JBIG program 201A, the probability estimation table memory 202 in the ROM 200 and the learning table memory 300 or the like to a package media such as a floppy disk or the like.

The CPU 100 operates in conformity with the JBIG program, which is stored in the ROM 200. The CPU 100 includes a register 101 for holding image data, which is read out from every block in an encoding target line, a register 102 for holding image data read out from every block in a line preceding the encoding target line by one line, a register 103 for holding image data read out from every block in a line preceding the encoding target line by two lines, a register 104 for holding a prediction result, a register 105 for holding a predicted value and a status value, which are read out from the learning table memory 300 and a register 106 for holding a range width for prediction-miss, which is read out from the probability estimation table memory 202.

Here, a block mean a unit for reading out, for example, sixteen pixels or eight pixels as one block from each line in the image data memory 400.

Furthermore, the CPU 100 has a register 107 for holding the contents of a context and a register 108 for holding flags indicating a result of investigating whether all the pixel in the encoding target line are white or not, a result of investigating whether all the pixels in the line preceding the encoding target line by one line are white or not and a result of investigating whether all the pixels in the line preceding the encoding target line by two lines are white or not. In response to the JBIG program 201A, the data, which are necessary for each register, are stored.

The CPU 100 realizes the first embodiment of the present invention by executing the JBIG program 201A in conformity with the JBIG system as will be explained later.

An example in which the ROM 200 stores the JBIG program 201A and the probability estimation table memory 202 fixedly was explained. However, in the case of altering this program, a memory such as a flash memory and an EEPROM or the like may be used. Alternatively, the JBIG program, which is read from an outer recording medium, may be stored in a DRAM or an SRAM.

The learning table, which is written in the RAM 300, stores a learning result as a table status while the CPU 100 repeatedly executes the JBIG program.

The FIFO memory 500 stores encoded data, which have been generated by the CPU 100 from image data stored in the image data memory 400.

Additionally, the recording medium driver 650 drives a recording medium to install contents of the JBIG program 201A to ROM 200 or the like. The recording medium driver 650 also drives a recording media, which stores, for example, the JBIG program 201A and the contents of the table of the probability estimation table memory 202 and the content of the learning table of the learning table memory 300.

The JBIG system encoding processing apparatus 700 includes the CPU 100, the ROM 200, the RAM 300, the RAM 400, the RAM 500 and the recording medium driver 650, and it performs compression encoding processing in conformity with the JBIG system.

An image memory 800 comprises a recording medium for inputting the image data from a scanner, a digital camera and an optical converting apparatus or the like to record the image data temporarily.

A transmission system 900 outputs the encoded image data supplied from the JBIG system encoding processing apparatus 700 to a receiving side such as a facsimile and a personal computer through a transmission line.

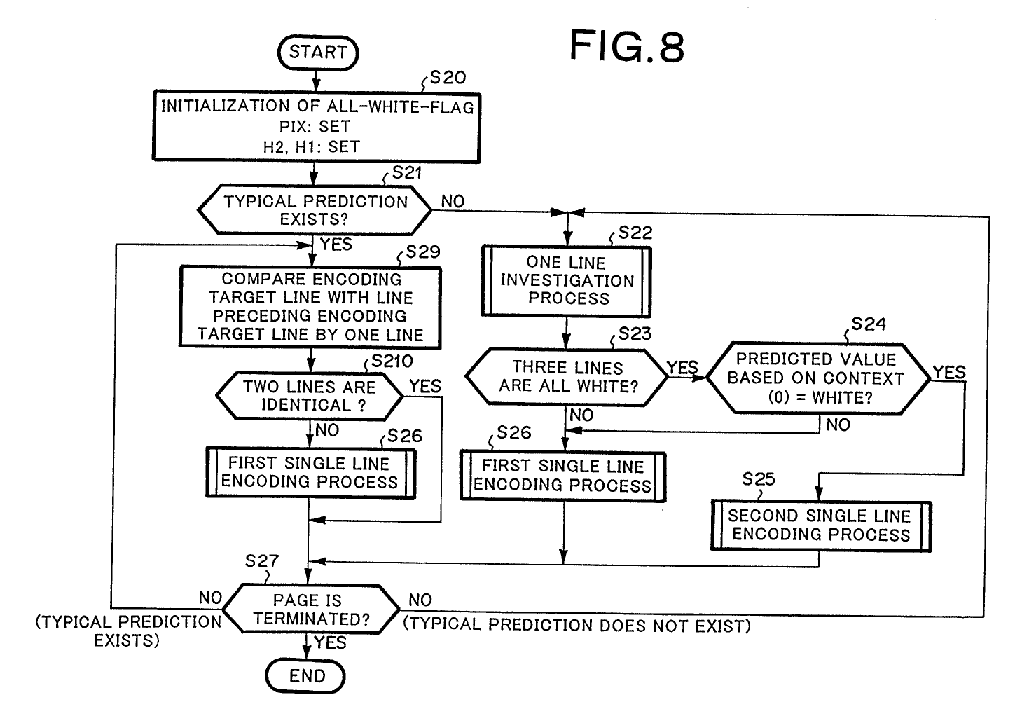

Next, a procedure of the JBIG program 201A in conformity with the JBIG system according to the first embodiment will be explained with reference to flowcharts shown in FIG. 8 through FIG. 10.

First, the whole operation will be explained with reference to FIG. 8.

At the beginning of the encoding processing for one page, three all-white-line flags, i.e., the first all-white-line flag PIX for the encoding target line, the second all-white-line flag H1 for the line preceding the encoding target line by one line, and the third all-white-line flag for the line preceding the encoding target line by two lines, are set (step S20).

Step S20 is performed to assume that there are a line preceding the first line of the image by one line and a line preceding the first line by two lines to cope with a case of encoding the first line.

Next, it is determined whether or not to perform a typical prediction in which the encoding target line PIX is compared with the line H1, which is preceding the encoding target line by one line (step S21). If the typical prediction should not be performed, one line investigation process is performed in which it is investigated whether or not all the pixels in the target line are white (step S22). If all the pixels in the target line are white, the all-white-line flag PIX is set, otherwise the all-white-line flag PIX is reset.

Next, it is determined whether or not all the three all-white-flags PIX, H1, and H2 are set (step S23). If all the three all-white-flags are set, that is, all the pixels in a region composed of the target line, the line preceding the target line by one line, and the line preceding the target line by two lines are white, it is determined whether or not the predicted value based on the context of which all the pixels are white is white (step S24). If the predicted value is white, a second single-line encoding process provided for a case where all the pixels in the region concerned is white is performed (step S25). If the result of determination at step S23 is negative, that is, at least one pixel in the region composed of the target line, the line preceding the target line by one line, and the line preceding the target line by two lines is not white, a first single-line encoding process provided for a case where at least one pixel in the region concerned is not white is performed (step S26). If the result of determination at step S23 is positive but the result of determination at step S24 is negative, the first single-line encoding process provided for the case where at least one pixel in the region concerned is not white is performed (step S26).

After performing step S25 or S26, it is determined whether or not all the lines in the manuscript are processed (step S27). If the result of determination at step S27 is negative, the flow returns to step S22. Otherwise, the operation is terminated.

If the result of determination at step S21 is positive, that is there is a typical prediction, the target line is compared with the line preceding the target line by one line (step S29). Then, it is determined whether or not the target line is the same as the line preceding the target line by one line (step S210). If they are not the same, the first single-line encoding process is performed (step S26). If they are the same the step S26 is skipped.

After performing or skipping the step S26, it is determined whether or not all the lines in the manuscript are processed (step S27). If the result of determination at step S27 is negative, the flow returns to step S29. Otherwise, the operation is terminated.

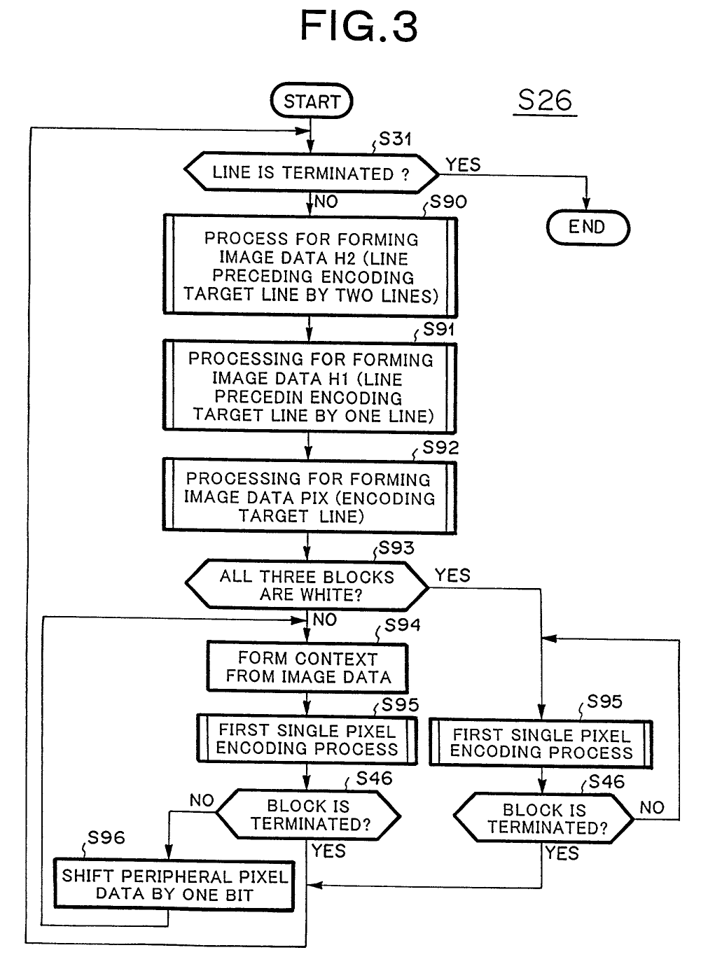

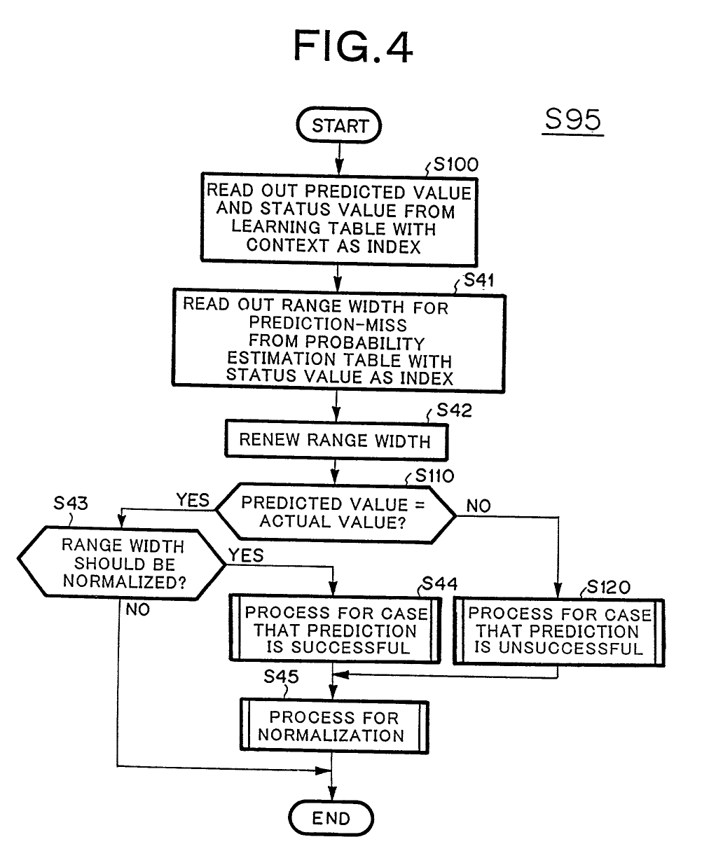

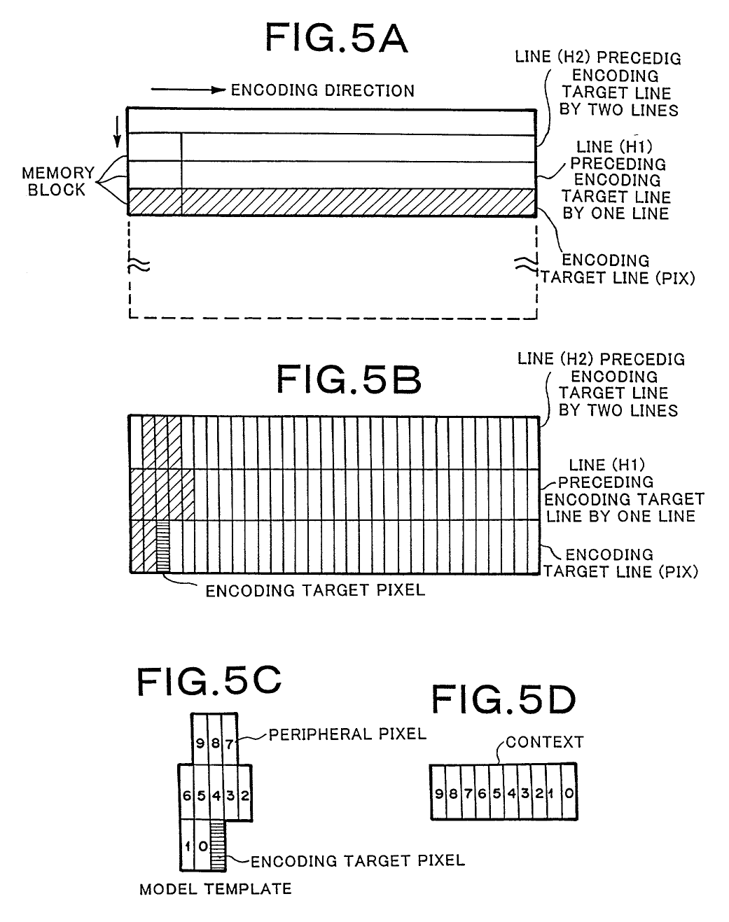

The first single-line encoding process (step S26) was explained with reference to FIG. 3, and explanation thereof is omitted here. The first single-pixel encoding process (step S95) in the first single-line encoding process (step S26) was also explained with reference to FIG. 4, and the explanation thereof is omitted here.

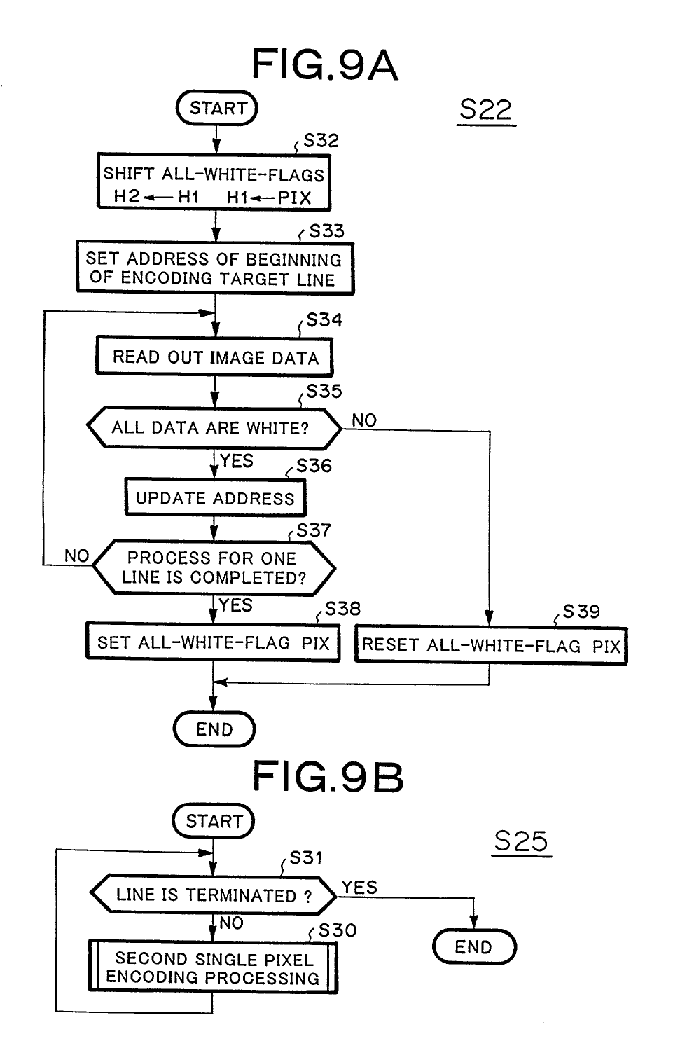

Next, the detail of step S22 will be explained with reference to FIG. 9A.

Referring to FIG. 9A, the all-white-line flags are shifted from line to line, that is, the all-white-line flag H1 is substituted to the all-white-line flag H2, and the all-white-line flag PIX is substituted to the all-white-line flag H1 (step S32).

Next, the top address of the target line in the image data memory 400 is loaded to the address pointer (not shown) of the CPU 100 (step S33). Image data are read from the address loaded to the address pointer, and are loaded to the register 101 (step S34). Here, in the prior art, it was not possible load the image data to the register 101 fully across the whole register width. On the other hand, according to the present invention, because it is not needed to form a context, it is possible to store the image data to the register fully across the whole register width, whereby the number of loading operations is decreased.

Next, it is determined whether or not all the pixels in the read image data are white (step S35). If the result of determination at step S35 is positive, the address in the address pointer is updated to the top address of the following pixels in the target line (step S36). That is, the address in the address pointer is increased by the width of the register 101. Next, it is determined whether or not all the pixels in the target line have been examined (step S37). If the result of determination at step S 37 is negative, the flow returns to step S34. Otherwise, the all-white-flag PIX for the target line is set (step S38).

If the result of determination at step S35 is negative, the all-white-flag PIX for the target line is reset (step S39).

Next, the detail of step S25 will be explained with reference to FIG. 9B.

Referring to FIG. 9B, in the second single-line encoding process, a second single-pixel encoding process (step S30), instead of the first single-pixel encoding process (step S95), for pixels in the target line is repeated until all the pixels in the target line are encoded (step S31). Here, the steps S90, S91, S92, S93, S94, and S96 in FIG. 3 are omitted as compared with the first single-line encoding process. The reason why such omission is possible is that if all the pixels in the three lines are white, a unique template (or context) of which all the pixels are white (i.e., zero) is applied to all the pixels in the target line, and it is not necessary to change a template (or context) every encoding target pixel.

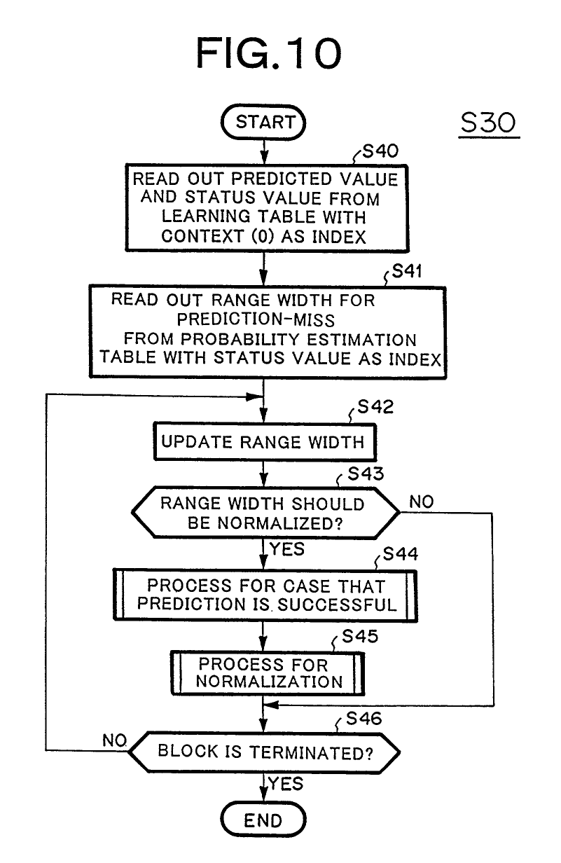

Next, the detail of the second single-pixel encoding process (step S30) will be explained with reference to FIG. 10 as follows:

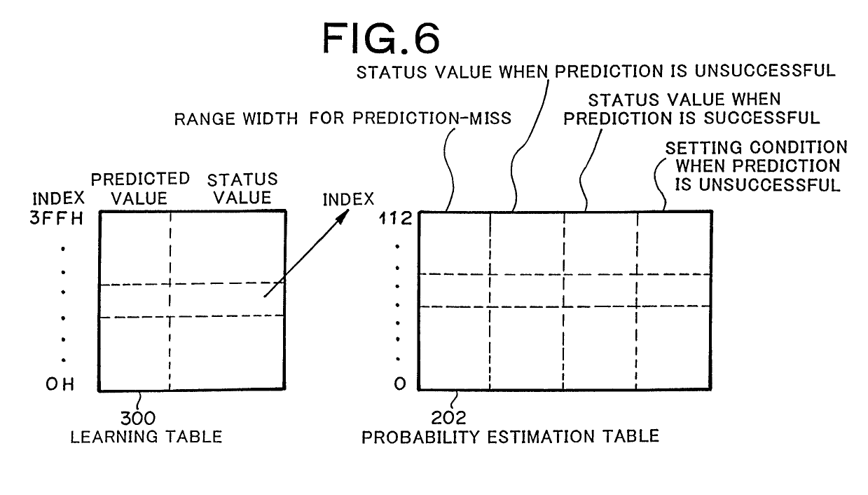

At first, the predicted value and the status value which correspond to the index which is formed of a context (0) are read from the learning table 300 (step S40). Here, context (0) represents the context of which all the pixels are white. Then, using the status value as an index, the range width for prediction-miss is read from the probability estimation table memory 202, together with the status value when the prediction is successful (step S41). Furthermore, by deducting the range width for prediction-miss from the range width showing probability that combination of white and black appears, the latter range width is updated (step S42). Here, the probability estimation table memory 202 conforms with the standard of the JBIG encoding system (recommendation T.82) and explained before with reference to FIG. 6.

Here, in the first single-pixel encoding process (step S95) in the first single-line encoding process (step S26), the process of determining whether the actual value of encoding target pixel is identical with the predicted value or not (step S110) is necessary. On the other hand, in the second single-pixel encoding process (step S30) in the second single-line encoding process (step S25), the process of determining whether the actual value of encoding target pixel is identical with the predicted value or not (step S110) is not necessary.

Next, it is determined whether the normalization process is required to be performed or not (step S43). If the determination result at step S43 is affirmative, a prediction-hit process is performed (step S44) and then, the normalization process is performed (step S45). If the determination result at step S43 is negative, the step S44 and S45 are skipped. Step S44 and step S45 were explained and the explanations thereof are omitted here. After performing or skipping steps S44 and S45, it is determined whether or not the block has been terminated (step S46). If the block has not been terminated, the encoding processing returns to the processing for renewing the range width (step S42). This is because the predicted value, the status value and the range width for prediction-miss are not changed, and are not needed to be read out.

The foregoing process enhances the encoding speed.

It is obvious that the present invention is especially effective for the image mainly composed of white pixels, such as a document image, which is frequently treated by a facsimile or the like. This JBIG encoded image data is transmitted to a facsimile in receiver side via the transmission system 900.

Copying the above program in the JBIG system to the recording medium, which is inserted in the recording medium driver 650, it may be possible to output this copied program as a recording package. Further, it may be possible to use the present recording package as an application in the JBIG system by other personal computer.

In the above embodiment, a case where a model template is composed of three lines was explained. However, the present invention is not limited to such model template, but may be generalized to cope with a case where a model template is composed pixels in two lines, a case where a model template is composed pixels in four lines, a case where a model template is composed pixels in several lines, and a case where a model template is composed pixels in a number of lines.

What is claimed is:

1. A method for encoding image data in conformity with Joint Bi-level Image Group system, comprising the steps of:
(a) determining whether or not a typical prediction should be performed;
(b) if a result of determination at step (a) is negative, determining whether or not all the pixels in a region composed of lines including pixels constituting a context are white;
(c) if a result of determination at step (b) is affirmative, determining whether or not a predicted value corresponding to a context of which all the pixels are white is white;
(d) if the result of determination at step (a) is affirmative, performing a first single line encoding process;
(e) if the result of determination at step (b) is negative, performing said first single line encoding process;
(f) if a result of determination at step (c) is negative, performing said first single line encoding process; and
(g) if the result of determination at step (c) is affirmative, performing a second single line encoding process.

2. The method according to claim 1,
wherein said first single line encoding process comprises the steps of:
(d-1) forming a context for each pixel in a target line;
(d-2) reading from a probability estimation table a range width for prediction-miss which corresponds to the context formed at step (d-1);
(d-3) updating a range width showing probability that combination of white and black appears using said range width for prediction-miss;
(d-4) predicting a value of each pixel in said target line on the basis of the context corresponding to the pixel;
(d-5) if the prediction is unsuccessful, performing a prediction-miss process for the pixel concerned; and
(d-6) if the prediction is unsuccessful, performing a normalization process for the pixel concerned.

3. The method according to claim 2,
wherein first single line encoding process further comprises the steps of:
(d-7) if the prediction is successful, determining whether or not a normalization is necessary for each pixel in said target line;
(d-8) if a result of determination at step (d-7) is affirmative, performing a prediction-hit process for the pixel concerned; and
(d-9) if the result of determination at step (d-7) is affirmative, performing said normalization process for the pixel concerned.

4. The method according to claim 1,
wherein said second single line encoding process comprises the steps of:
(g-1) forming a context of which all the pixels are white and which is common to the pixels in a target line;
(g-2) reading from a probability estimation table a range width for prediction-miss which corresponds to the context formed at step (g-1);
(g-3) updating a range width showing probability that combination of white and black appears using said range width for prediction-miss; and
(g-4) omitting to predict a value of each pixel in said target line.

5. The method according to claim 4,
wherein said second single line encoding process further comprises the steps of:
(g-5) determining whether or not a normalization process is necessary for each pixel in said target line;
(g-6) if a result of determination at step (g-5) is affirmative, performing a prediction hit process for the pixel concerned; and
(g-7) if the result of determination at step (g-5) is affirmative, performing said normalization process for the pixel concerned.

6. A computer program product for having a computer execute a method for encoding image data in conformity with Joint Bi-level Image Group system, said method comprising the steps of:
(a) determining whether or not a typical prediction should be performed;
(b) if a result of determination at step (a) is negative, determining whether or not all the pixels in a region composed of lines including pixels constituting a context are white;
(c) if a result of determination at step (b) is affirmative, determining whether or not a predicted value corresponding to a context of which all the pixels are white is white;
(d) if the result of determination at step (a) is affirmative, performing a first single line encoding process;
(e) if the result of determination at step (b) is negative, performing said first single line encoding process;
(f) if a result of determination at step (c) is negative, performing said first single line encoding process; and
(g) if the result of determination at step (c) is affirmative, performing a second single line encoding process.

7. The computer program product according to claim 6,
wherein said first single line encoding process comprises the steps of:
(d-1) forming a context for each pixel in a target line;
(d-2) reading from a probability estimation table a range width for prediction-miss which corresponds to the context formed at step (d-1);
(d-3) updating a range width showing probability that combination of white and black appears using said range width for prediction-miss;
(d-4) predicting a value of each pixel in said target line on the basis of the context corresponding to the pixel;
(d-5) if the prediction is unsuccessful, performing a prediction-miss process for the pixel concerned; and
(d-6) if the prediction is unsuccessful, performing a normalization process for the pixel concerned.

8. The computer program product according to claim 7,
wherein first single line encoding process further comprises the steps of:
(d-7) if the prediction is successful, determining whether or not a normalization is necessary for each pixel in said target line;
(d-8) if a result of determination at step (d-7) is affirmative, performing a prediction-hit process for the pixel concerned; and
(d-9) if the result of determination at step (d-7) is affirmative, performing said normalization process for the pixel concerned.

9. The computer program product according to claim 6,
wherein said second single line encoding process comprises the steps of:
(g-1) forming a context of which all the pixels are white and which is common to the pixels in a target line;
(g-2) reading from a probability estimation table a range width for prediction-miss which corresponds to the context formed at step (g-1);
(g-3) updating a range width showing probability that combination of white and black appears using said range width for prediction-miss; and
(g-4) omitting to predict a value of each pixel in said target line.

10. The computer program product according to claim 9,
wherein said second single line encoding process further comprises the steps of:
(g-5) determining whether or not a normalization process is necessary for each pixel in said target line;
(g-6) if a result of determination at step (g-5) is affirmative, performing a prediction hit process for the pixel concerned; and
(g-7) if the result of determination at step (g-5) is affirmative, performing said normalization process for the pixel concerned.

11. An apparatus for encoding image data in conformity with Joint Bi-level Image Group system, comprising:
(a) means for determining whether or not a typical prediction should be performed;
(b) means, if a result of determination by means (a) is negative, for determining whether or not all the pixels in a region composed of lines including pixels constituting a context are white;
(c) means, if a result of determination by means (b) is affirmative, for determining whether or not a predicted value corresponding to a context of which all the pixels are white is white;
(d) means, if the result of determination by means (a) is affirmative, for performing a first single line encoding process;
(e) means, if the result of determination by means (b) is negative, performing said first single line encoding process;
(f) means, if a result of determination by means (c) is negative, for performing said first single line encoding process; and
(g) means, if the result of determination by means (c) is affirmative, for performing a second single line encoding process.

12. The apparatus according to claim 11,
wherein said first single line encoding process comprises the steps of:
(d-1) forming a context for each pixel in a target line;
(d-2) reading from a probability estimation table a range width for prediction-miss which corresponds to the context formed at step (d-1);
(d-3) updating a range width showing probability that combination of white and black appears using said range width for prediction-miss;
(d-4) predicting a value of each pixel in said target line on the basis of the context corresponding to the pixel;
(d-5) if the prediction is unsuccessful, performing a prediction-miss process for the pixel concerned; and
(d-6) if the prediction is unsuccessful, performing a normalization process for the pixel concerned.

13. The apparatus according to claim 12,
wherein first single line encoding process further comprises the steps of:
(d-7) if the prediction is successful, determining whether or not a normalization is necessary for each pixel in said target line;
(d-8) if a result of determination at step (d-7) is affirmative, performing a prediction-hit process for the pixel concerned; and
(d-9) if the result of determination at step (d-7) is affirmative, performing said normalization process for the pixel concerned.

14. The apparatus according to claim 11,
wherein said second single line encoding process comprises the steps of:
(g-1) forming a context of which all the pixels are white and which is common to the pixels in a target line;
(g-2) reading from a probability estimation table a range width for prediction-miss which corresponds to the context formed at step (g-1);
(g-3) updating a range width showing probability that combination of white and black appears using said range width for prediction-miss; and
(g-4) omitting to predict a value of each pixel in said target line.

15. The apparatus according to claim 14,
wherein said second single line encoding process further comprises the steps of:
(g-5) determining whether or not a normalization process is necessary for each pixel in said target line;
(g-6) if a result of determination at step (g-5) is affirmative, performing a prediction hit process for the pixel concerned; and
(g-7) if the result of determination at step (g-5) is affirmative, performing said normalization process for the pixel concerned.
